(19) United States
(12) Patent Application Publication
(10) Pub. No.: US 2016/0147432 A1
(43) Pub. Date: May 26, 2016

(54) AUTOMATICALLY RETURNING TO AN ACTIVE WINDOW DURING A MEETING

(71) Applicants: Qi Shi, Suzhou (CN); Huahua Yin, Suzhou (CN); Hua Ouyang, Suzhou (CN); Guoxin Zhou, Suzhou (CN)

(72) Inventors: Qi Shi, Suzhou (CN); Huahua Yin, Suzhou (CN); Hua Ouyang, Suzhou (CN); Guoxin Zhou, Suzhou (CN)

(73) Assignee: CISCO TECHNOLOGY, INC., San Jose, CA (US)

(21) Appl. No.: 14/550,371

(22) Filed: Nov. 21, 2014

(51) Int. Cl. G06F 3/0485; G06F 3/0482; G06F 3/0484; H04L 29/06

(52) U.S. Cl. CPC G06F 3/04855; H04L 65/403; G06F 3/0482; G06F 3/04842

(57) ABSTRACT

According to one aspect, a method includes identifying a shared window, the shared window being at least partially rendered on a screen of a device and having a first border that defines an edge of the shared window. The method also includes determining if scrolling beyond the first border is detected and, if it is determined that scrolling beyond the first border is detected, determining whether bounding back to the shared window is indicated. Finally, the method includes bounding back to the shared window if it is determined that bounding back to the shared window is indicated, and allowing the scrolling beyond the first border to continue if it is determined that bounding back to the shared window is not indicated.

### TECHNICAL FIELD

The disclosure relates generally to collaborative environments. More particularly, the disclosure related to allowing a remote device that is participating in a collaborative meeting to efficiently scroll through an active window or a display screen.

### BACKGROUND

Meetings or conferences with online components, e.g., collaborative sessions, are often joined by remote participants who are using mobile devices such as cellular phones. Due to the size of display screens of mobile devices, participants in collaborative sessions who are attending or otherwise participating in the collaborative sessions using the mobile devices often find it desirable to use zoom and/or scroll operations with respect to the display screens. For example, when a presenter in a collaborative session is sharing a file that is displayed on his or her desktop, a user of a mobile device may effectively scroll over the shared file in order to display different portions of the file on a display screen of the mobile device.

During the course of scrolling over a shared file, or a file displayed in a shared window, such that different areas of the shared file may be viewed on a display screen of a mobile device, a user may scroll past a border of the shared window. When the user inadvertently, or unintentionally, scrolls past a border of a shared window, the experience of the user during a collaborative session may be compromised. When a user inadvertently scrolls past a border of a shared window rendered on a display of a mobile device, it may be time-consuming for the user to relocate the shared window such that the shared window may be rendered on the display.

### BRIEF DESCRIPTION OF THE DRAWINGS

The disclosure will be readily understood by the following detailed description in conjunction with the accompanying drawings in which:

FIG. 1 is a process flow diagram which illustrates one method of addressing scrolling with respect to a shared window in accordance with an embodiment.

FIG. 2A is a diagrammatic representation of a mobile device that is arranged to display a portion of a shared window associated with a shared application at a time t1 in accordance with an embodiment.

FIG. 2B is a diagrammatic representation of a mobile device, e.g., mobile device 212 of FIG. 2A, at a time t2 at which the mobile device has been used to scroll to an edge of the active window in accordance with an embodiment.

FIG. 2C is a diagrammatic representation of a mobile device, e.g., mobile device 212 of FIG. 2A, at a time t3 at which a bound back has occurred such that the display of the active window on the mobile device is substantially at the border of the active window in accordance with an embodiment.

FIG. 3A is a diagrammatic representation of a mobile device that is arranged to display a portion of a shared window associated with a shared desktop at a time t1 in accordance with an embodiment.

FIG. 3B is a diagrammatic representation of a mobile device, e.g., mobile device 312 of FIG. 3A, at a time t2 at which the mobile device has been used to scroll to an edge of the shared window in accordance with an embodiment.

FIG. 3C is a diagrammatic representation of a mobile device, e.g., mobile device 312 of FIG. 3A, at a time t3 at which a bound back has occurred such that the display of the shared window on the mobile device is substantially at the border of the shared window in accordance with an embodiment.

FIG. 4A is a diagrammatic representation of a mobile device that is arranged to display a portion of a first shared window associated with a shared application at a time t1 in accordance with an embodiment.

FIG. 4B is a diagrammatic representation of a mobile device, e.g., mobile device 412 of FIG. 4A, at a time t2 at which the mobile device has been used to scroll to substantially past an edge of the first shared window in accordance with an embodiment.

FIG. 4C is a diagrammatic representation of a mobile device, e.g., mobile device 412 of FIG. 4A, at a time t3 at which a bounding process has occurred such a screen of the mobile device is scrolled to the border of a second window in accordance with an embodiment.

FIG. 5 is a process flow diagram which illustrates a method of obtaining and providing information that allows a mobile device to automatically bound back to a shared window when the mobile device is used to effectively scroll pass a border of the shared window in accordance with an embodiment.

FIG. 6 is a diagrammatic representation of a mobile device in accordance with an embodiment.

### DESCRIPTION OF EXAMPLE EMBODIMENTS

### General Overview

In one embodiment, a method includes identifying a shared window, the shared window being at least partially rendered on a screen of a device and having a first border that defines an edge of the shared window. The method also includes determining if scrolling beyond the first border is detected and, if it is determined that scrolling beyond the first border is detected, determining whether bounding back to the shared window is indicated. Finally, the method includes bounding back to the shared window if it is determined that bounding back to the shared window is indicated, and allowing the scrolling beyond the first border to continue if it is determined that bounding back to the shared window is not indicated.

### DESCRIPTION

Participants in meetings or conferences which share content online, e.g., collaborative sessions during which content is shared, are often remote participants, or participants who take part in the meetings or conferences using mobile devices such as cellular phones. Content may be shared visually. For example, a window associated with a shared desktop or a window associated with a shared application may be rendered on a screen or a mobile device such that a user of the mobile device may view contents of the meeting.

During a meeting in which information is shared visually, e.g., during a collaborative session in which a presenter shares the desktop of his computing device, the shared information may be rendered for display on display screens in the possession of parties attending the meeting. By way of example, during a collaborative session or an online meeting, a remote or virtual attendee may view shared content on a display screen of his or her mobile device. Thus, a rendering of shared content is provided on the display screen of the mobile device. As such, when the user scrolls using the display screen of his or her mobile device, the user effectively moves the display screen over the shared content. It should be appreciated that the shared content may be any content that is displayed in a window on a screen associated with a presenter who is participating in the collaborative session.

Scrolling may occur such that a user effectively scrolls past a border or an edge of a shared window, or an active window, rendered on a screen of his or her mobile device. In one embodiment, when the user uses a scroll bar to scroll past a border of a shared window, an auto-bound-back process may enable a bound back or bounce back to occur such that the scroll bar effectively moves back to the border of the shared window. By allowing the scroll bar to substantially move back to the border of the shared window after a user uses the scroll bar to scroll past the border, the user may be able be able to efficiently focus on the shared window. As a result, collaboration between a presenter who is sharing the content in a shared window and the user who is viewing the content on a screen of a mobile device may be enhanced.

As will be appreciated by those skilled in the art, scrolling may be an operation or action of effectively moving or otherwise sliding contents across a display screen such that different portions of the contents may be viewed on the display screen. For example, when contents are part of a displayed window of a shared desktop that is larger than the size of a display screen of a mobile device, scrolling may allow different portions of the displayed window of the shared desktop to be presented or rendered on the display screen. Scrolling may occur such that contents are effectively moved up with respect to the display screen, down with respect to the display screen, or across the display screen. The contents that are effectively moved or otherwise slid across a display screen may include, but are not limited to including, text, graphics, images, and/or video. The display screen may be, in one embodiment, a screen of a mobile device such as a cell phone.

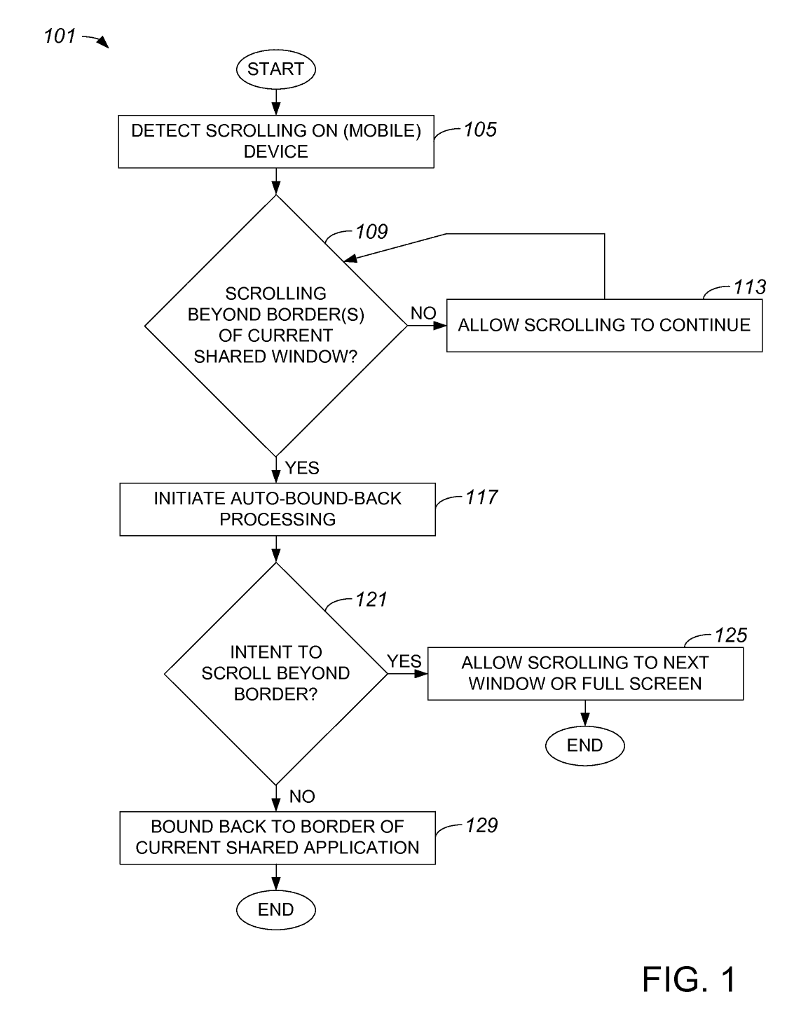

Referring initially to FIG. 1, one method of responding to scrolling with respect to a shared window during a meeting session in which at least one window may be shared will be described in accordance with an embodiment. A method 101 of responding to scrolling begins at step 105 in which scrolling is detected on a device, e.g., a mobile device such as a mobile phone or tablet. Scrolling may be detected by the device itself. In other words, a mobile device may determine when the mobile device is being used to substantially scroll with respect to a window of a different device. For example, a participant in a meeting who is in possession of a mobile device may use the mobile device to view a rendering of a shared window associated with a current presenter during the meeting, and may use the mobile device to effectively scroll with respect to the shared window. Scrolling may include causing scroll bar to move across a rendering of a shared window on a mobile device and/or causing a cursor to move across the rendering of the shared window on the mobile device.

A determination is made in step 109 as to whether scrolling is occurring beyond at least one border of a current shared window, e.g., whether a scroll bar and/or a cursor is scrolled past the at least one border of the current shared window. It should be appreciated that a current shared window is typically an active window. The border of the current shared window effectively defines an edge of the current shared window. If it is determined that scrolling is not occurring beyond a border of a current shared window, then scrolling is allowed to continue in step 113. From step 113, process flow returns to step 109 in which it is determined whether scrolling is occurring beyond at least one border of a current shared window.

Alternatively, if the determination in step 109 is that scrolling is occurring beyond at least one border of the current window, the indication is that a user of the device has scrolled substantially past the borders or edges of the current window. As such, auto-bound-back processing is initiated in step 117. Auto-bound-back processing allows the representation of the current window, as displayed on the device, to effectively be moved, or bounded back, such as the device displays at least an edge of the current window. In one embodiment, auto-bound-back processing may be arranged to cause a scroll bar may be moved, or bounded back, such that the scroll bar may effectively be repositioned over the current window. In order for auto-bound-back processing to determine an appropriate time to bound back to a current window, the device may obtain information relating to borders of the current window, as for example from a device used by a presenter of the current window.

Bounding back to a border of a current window, or bouncing back to the border of the current window, generally refers to automatically causing a view or representation of a current window to be displayed on a display screen such that contents of the current window are visible on the display screen. In one embodiment, after a scroll bar is used to scroll past a boundary of a current window, a bound back or bounce back may occur such that the scroll bar is repositioned substantially over the current window such that the current window is displayed. For example, when a scroll bar is used to scroll to the right past a right-hand-side border of a current or active window such that the current window is not displayed on a display screen, bounding back or bouncing back to the border of the current window effectively causes the scroll bar to automatically be moved back to the right-hand-side border such that the active window is displayed on the display screen. It should be appreciated that when a scroll bar scrolls past a border of an active window in one direction, a bound back or a bounce back may cause the scroll bar to substantially automatically scroll back in the opposite direction, e.g., move back over the border in the opposite direction.

Once auto-bound-back processing is initiated, a determination is made in step 121 as to whether there was an intent to scroll beyond the border of the current window. In other words, it is determined whether a user of the device, e.g., an owner of a mobile device, intentionally scrolled past the edges or borders of the current window. For example, a user of the device may intentionally scroll past a border as a part of a drag and drop. In one embodiment, how far the user of the device has scrolled past the border may be a consideration in determining an intent to scroll past the border, e.g., scrolling past a threshold distance may be indicative of an intent to scroll pas the border.

If the determination in step 121 is that there was an intent to scroll beyond the border of the current window, then scrolling is allowed to continue to another window or a full screen in step 125. In one embodiment, allowing scrolling to continue may include causing a bounce to or bound to process allows the display or screen of the device to effectively be repositioned over another window. After scrolling is allowed to continue, the method of responding to scrolling is completed.

Alternatively, if the determination in step 121 is that there is no intent to scroll beyond the border, the implication is that a user of the device is intending substantially only to scroll to a border of the current window. As such, process flow moves from step 121 to step 129 in which bound back or bounce back occurs. Bound back occurs to effectively reposition the display or screen of the device at a border of the current window. Such repositioning may occur by moving a scroll bar along the display or screen back to the border of the current window. That is, in step 129, the display of the device is effectively repositioned to display an area of the current window near the border of the current window. Once bound back occurs, the method of responding to scrolling is completed.

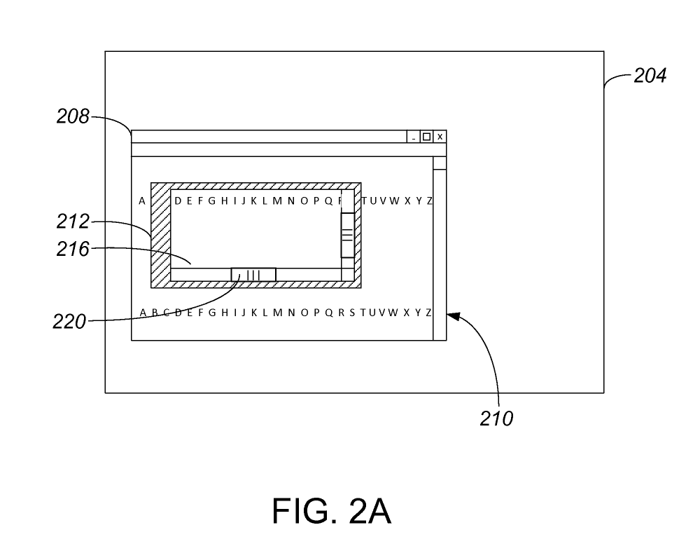

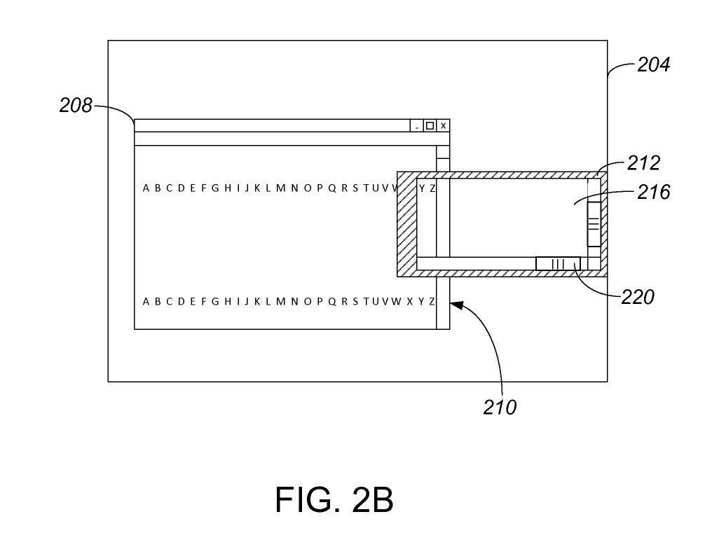

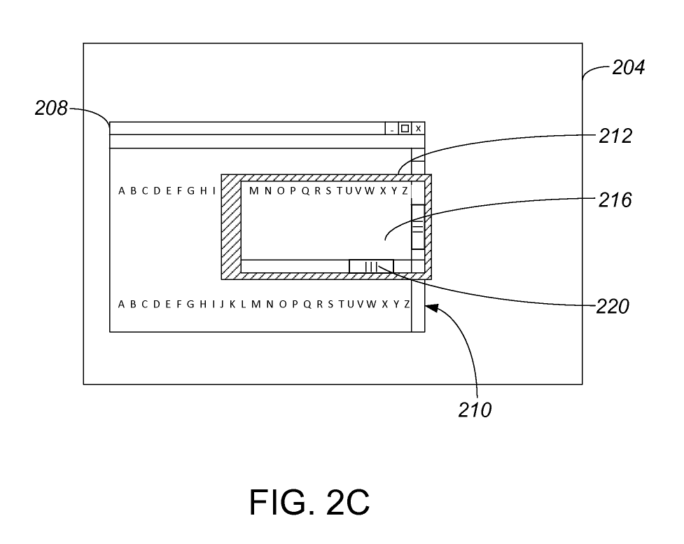

When an application window associated with a shared application is shared, a screen of a mobile device may substantially automatically bounce back or bound back to a border of the application window when a user of the mobile device effectively scrolls past a border of the shared application. With reference to FIGS. 2A-C, a process of automatically bouncing back to a border of a shared application will be described.

FIG. 2A is a diagrammatic representation of a mobile device that is arranged to display a portion of a shared window associated with a shared application at a time t1 in accordance with an embodiment. A display screen 204 is arranged to display a window 208 associated with a shared application, or an application that is being shared on display screen 204.

A mobile device 212, which includes a screen 216, is arranged to participate in a session or a meeting in which display screen 204 is used to share window 208. A scroll bar 220 displayed on screen 216 is configured to enable a user of mobile device 212 to effectively scroll substantially over display screen 204 such that portions of display screen 204 are shown on screen 216. As will be appreciated by those skilled in the art, a user of mobile device 212 may scroll using scroll bar 220 by effectively dragging scroll bar 220 along screen 216. At a time t1, as shown, a portion of window 208 is displayed on screen 216.

Scroll bar 220 is arranged to allow scrolling relative to screen 216, and is not arranged relative to window 208. As shown, scroll bar 220 is allowed to provide scrolling relative to a width of screen 216, rather than relative to window 208.

When a user of mobile device 212 scrolls with respect to window 208, screen 216 may essentially be scrolled past at least one border 210 of window 208. In other words, during scrolling, screen 216 may be scrolled such that portions of display screen 204 other than window 208 may be displayed or otherwise rendered on screen 216. FIG. 2B is a diagrammatic representation of mobile device 212 at a time t2 at which the mobile device has been used to scroll to an edge of the window 208 in accordance with an embodiment. As shown, screen 216 is scrolled substantially past border 210 of window 208 such that border 210 of window 208 is visible on screen 216. In other words, screen 216 is scrolled past border 210 such that at least a partial rendering of window 208 does not substantially fill screen 216.

Once scroll bar 220 is used to effectively scroll past border 210, an auto-bound-back process may be initiated to cause screen 216 to substantially bound back or bounce back to displaying primarily contents associated with window 208, and not other areas of display screen 204. Bound back or bounce back may include moving scroll bar 220 back to a position which corresponds to border 210. In one embodiment, scrolling may cause a cursor to move past border 210, and an auto-bound-back process may cause the cursor to move back to, or bound back to, window 208. With reference to FIG. 2C, mobile device 212 is shown at a time t3 at which a bound back or bounce back has occurred such that the display or rendering of window 208 is substantially at the border 210 in accordance with an embodiment. At a time t3, after it is detected, e.g., by mobile device 212, that screen 216 has been scrolled past border 210, a bound back or bounce back process causes screen 216 to bound back or bounce back to border 210 such that contents of window 208 are displayed without other areas of display screen 204 being displayed. In other words, screen 216 may be automatically scrolled back to border 210 such that portions of window 208 are displayed on screen 216 substantially alone, e.g., portions of window 208 effectively fill screen 216. As shown, an edge of screen 216 may be substantially lined up with border 210 such that parts of window 208 are displayed on screen 216.

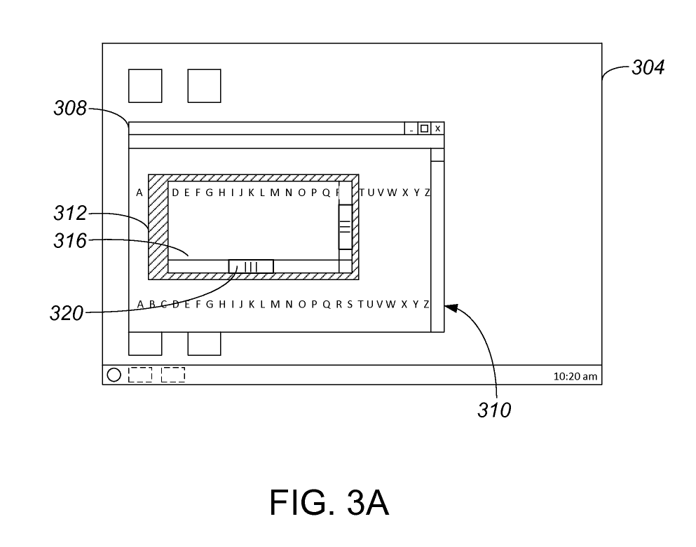

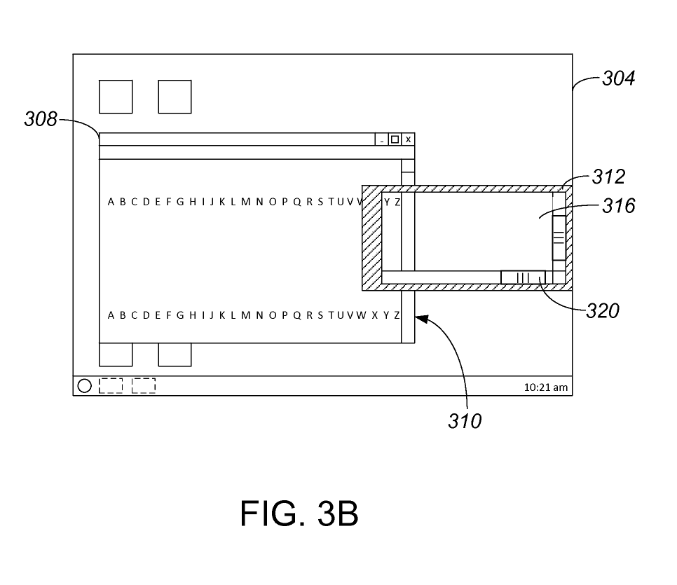

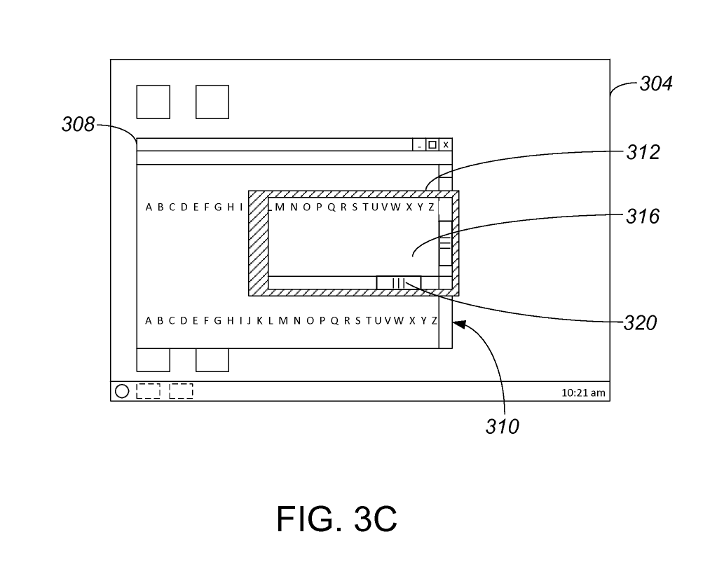

Window 208 has been described as being associated with a shared application. In general, a shared window may be any window associated with a desktop shared during a collaborative meeting or session. Referring next to FIGS. 3A-C, a process of automatically bouncing back to a border of a shared window associated with a shared desktop will be described in accordance with an embodiment.

FIG. 3A is a diagrammatic representation of a mobile device that is arranged to display a portion of a shared window associated with a shared desktop at a time t1 in accordance with an embodiment. A shared desktop 304, which may be displayed on a display screen associated with a presenter in a collaborative meeting, displays a window 308 that is shared, e.g., active, during the collaborative meeting. The background of shared desktop 304 may generally include icons that represent different applications.

A mobile device 312, which includes a screen 316, is arranged to participate in a session or a meeting that involves shared desktop 304, and in which window 308 is shared. A scroll bar 320 displayed on screen 316 is configured to enable a user of mobile device 312 to effectively scroll substantially over shared desktop 304 such that portions of shared desktop 304 are shown, or rendered, on screen 316. As will be appreciated by those skilled in the art, a user of mobile device 312 may scroll using scroll bar 320 by effectively dragging scroll bar 320 along screen 316. At a time t1, as shown, screen 316 is effectively arranged over window 308 such that substantially only a portion of window 308 is displayed or rendered on screen 316.

A user of mobile device 312 may scroll with respect to window 308 or, more generally, with respect to shared desktop 304. During scrolling, screen 316 may be scrolled such that portions screen 316 may display or render portions of shared desktop 304 in addition to, or in lieu of, a portion of window 308. That is, screen 316 may effectively scroll past a border 310 of window 308.

FIG. 3B is a diagrammatic representation of mobile device 312 at a time t2 at which the mobile device has been used to scroll to a border or an edge of window 308. At a time t2, screen 316 is scrolled substantially past border 310 of window 308 such that border 310 of window 308 is visible on screen 316. Screen 316 depicts, or displays, contents of window 308, border 310, and a portion of shared desktop 310. As shown, scroll bar 320 has scrolled past or otherwise moved past border 310.

After scroll bar 320 is used to effectively scroll past border 310, an auto-bond-back process may be initiated to cause screen 316 to substantially bound back or bounce back to displaying primarily contents associated with window 308, substantially without displaying other areas of shared desktop 304. With reference to FIG. 3C, a mobile device 312 is shown at a time t3 at which a bound back has occurred such that screen 316 is substantially at border 310 of window 308. At a time t3, after it is detected, e.g., by mobile device 312, that screen 316 has been scrolled past border 310, a bound back or bounce back process causes screen 316 to bound back or bounce back to border 310 such that contents of window 208 are displayed without other areas of shared desktop 304 being displayed or rendered on screen 316. That is, screen 316 may be automatically scrolled back to border 310 such that substantially only portions of window 308 are displayed on screen 316, and such that scroll bar 320 is moved back over window 308. Moving scroll bar 320 back over window 308 includes moving scroll bar back across border 310 such that scroll bar 320 is positioned over window 308.

In one embodiment, there may be more than one window that is open and shared. For example, a presenter during a collaborative session may share his or her desktop, and his or her desktop may have multiple open windows. Alternatively, a presenter during a collaborative session may also share more than one application, e.g., more than one shared window may be displayed on a display screen used by the presenter. Where more than one shared window is displayed on a display screen used by a presenter during a collaborative session, a participant in the collaborative session who is using a mobile device to participate in the collaborative session may wish to scroll from one shared window to another shared window. When the participant uses his or her mobile device to scroll past a border of one shared window, it may be determined that the participant intends to scroll to another shared window. If it is determined that the participant intends to scroll to a different shared window, an automatic bounce or bound process may cause a screen of the mobile device to bounce to or bound to the different shared window.

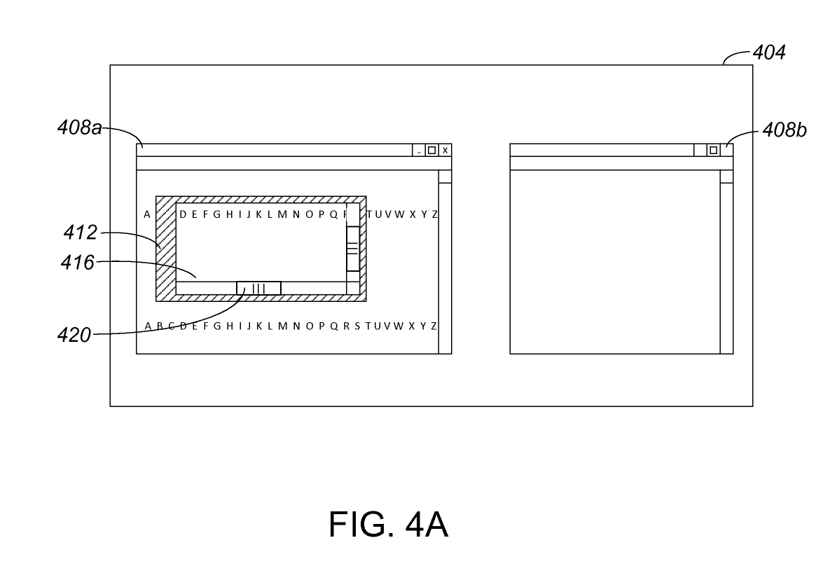

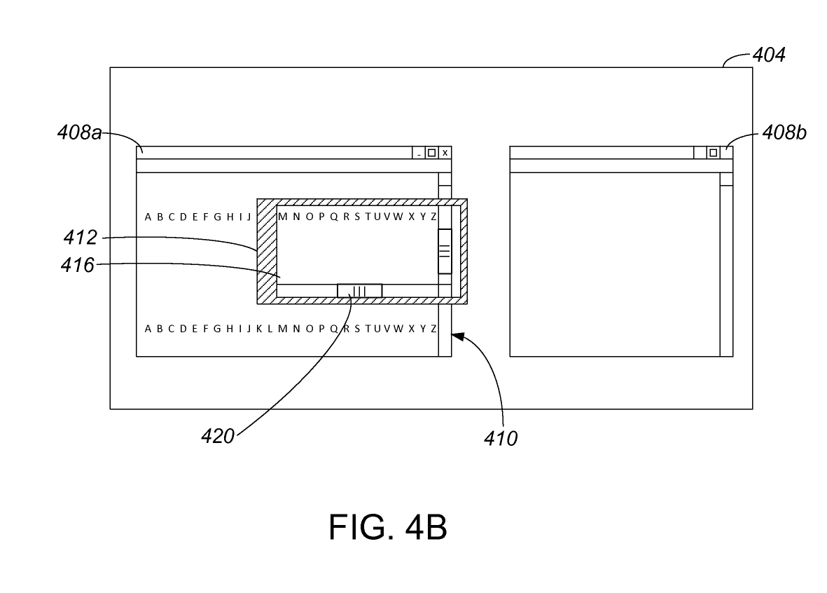

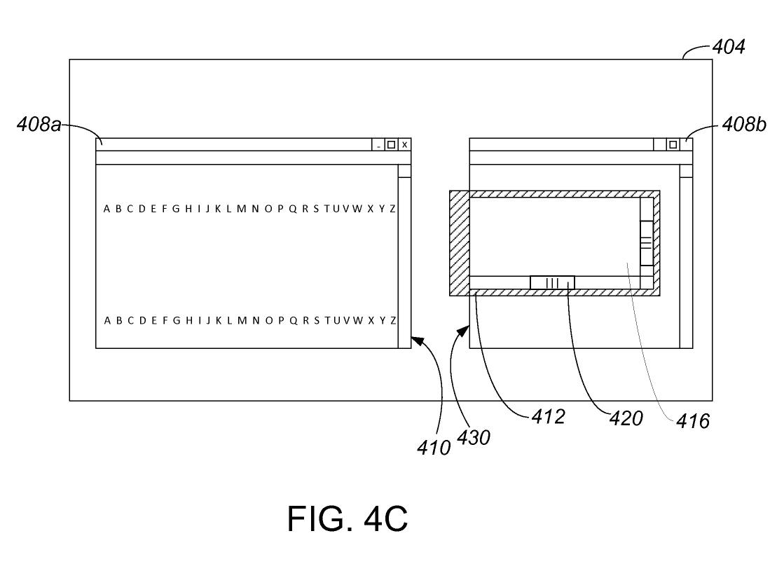

Referring next to FIGS. 4A-C, a process of automatically bouncing to a second shared window when a mobile device is used to scroll past a boundary of a first shared window will be described in accordance with an embodiment. FIG. 4A is a diagrammatic representation of a mobile device that is arranged to display a portion of a first shared window associated with a shared application at a time t1 in accordance with an embodiment. A display screen 404 displays a first window 408a and a second window 408b that are arranged to be shared during a collaborative session or meeting. In the described embodiment, first window 408a is associated with a first application and second window 408b is associated with a second application. It should be appreciated, however, that first window 408a and second window 408b may instead be windows displaying content associated with a shared desktop.

At a time t1, a screen 416 of a mobile device 412 is arranged such that contents of first window 408a are displayed on, or rendered in, screen 416. Using a scroll bar 420, a user may cause screen 416 to effectively scroll over window 408a. At a time t2, as shown in FIG. 4B, scroll bar 420 has been used by a user to cause screen 416 to effectively scroll at least partially past a border 410 of first window 408a. As shown, a rendering of part of first window 408a, including a part of border 410, is present on screen 416.

As mentioned above, a user may use mobile device 412 to effectively scroll at least partially past a border 410 of first window 408a with an intention to scroll to second window 408b. When such an intention is identified, an auto-bound-back process may be implemented to substantially automatically scroll screen 416 to second window 408b. In other words, screen 416 may be bound to or bounced to second window 408b. An intention to scroll to second window 408b may be indicated, in one embodiment, by how far past border 410 a user has scrolled. For example, if the user has scrolled past a threshold distance, such as a distance approximately halfway between first window 408a and second window 408b, then an intent to scroll to second window 408b may be indicated.

FIG. 4C shows mobile device 412 at a time t3 at which an auto-bound-back process has occurred such that second window 408b is displayed or rendered on screen 416. At a time t3, an auto-bound-back process effectively causes screen 416 to bound to or bounce to a border 430 of second window 408b. In the embodiment as shown, screen 416 is substantially automatically scrolled to a position in which screen 416 is approximately lined up with border 430 such that portions of second window 408b are displayed or rendered on screen 416.

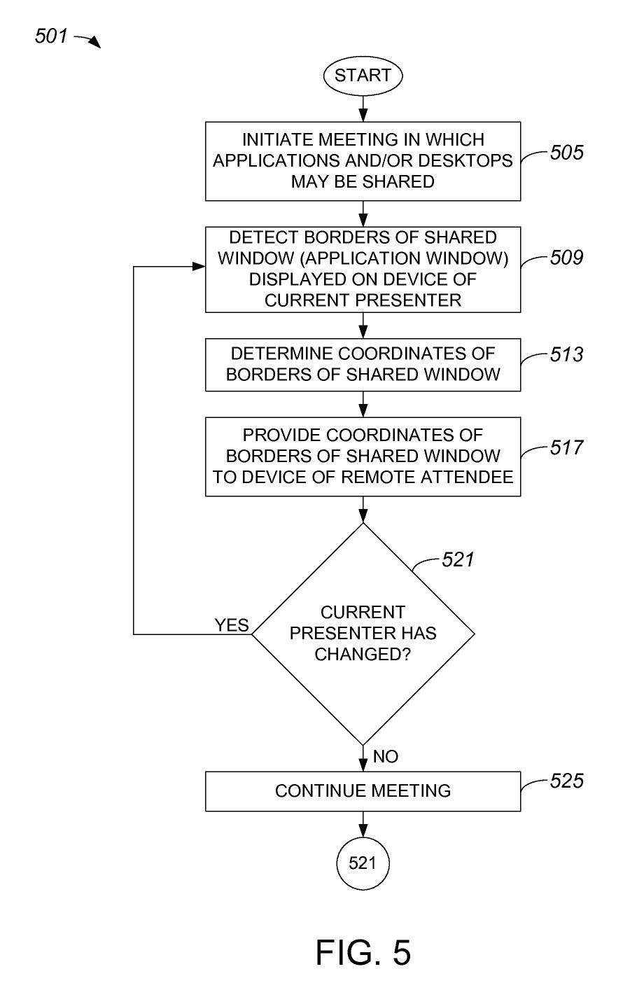

As previously mentioned, information relating to the borders of an active window or a shared window may be obtained and provided to a mobile device to facilitate a bound back process. By way of example, window coordinates of a shared application window may be detected by a meeting or conference server, and then provided to a remote mobile device for use in determining when the remote mobile device has been used to scroll past a border or an edge of the shared application window. With reference to FIG. 5, a method of obtaining and providing information that allows a mobile device to automatically bound back to a shared window when the mobile device is used to effectively scroll pass a border of the shared window will be described in accordance with an embodiment. A method 501 of obtaining and providing information to facilitate a bound back process begins at step 505 in which a meeting in which applications and/or desktops may be shared is initiated. In one embodiment, a multimedia collaboration session may be initiated.

In step 509, borders of a shared window, e.g., a shared application window, displayed on a device of a current presenter are detected. For example, a shared window displayed on a computer display screen used by a current presenter may be detected. In one embodiment, a meeting server that supports the meeting may identify the borders of the shared window.

Once the borders of the shared window are detected, coordinates of the borders may be determined in step 513, e.g., determined by a meeting server. Determining coordinates of the borders of the shared window may include, but is not limited to including, determining Cartesian coordinates of the corners of the shared window. After the coordinates of the borders are determined, the coordinates are provided in step 517 to a device used by a remote attendee of the meeting, e.g., to a mobile phone of the remote attendee. A meeting server may determine the coordinates of the borders and provide the coordinates of the borders to the device used by the remote attendee of the meeting.

A determination is made in step 521 as to whether the current presenter has changed. In other words, it is determined whether there is a new current presenter who is sharing a window on his or her device, e.g., computing device with a display screen. If it is determined in step 521 that the current presenter has changed, then process flow returns to step 509 in which borders of a shared window displayed on the device of the current presenter are detected.

Alternatively, if it is determined in step 521 that the current presenter has not changed, the meeting continues in step 525. From step 525, process flow returns to step 521 in which a determination is made as to whether the current presenter has changed.

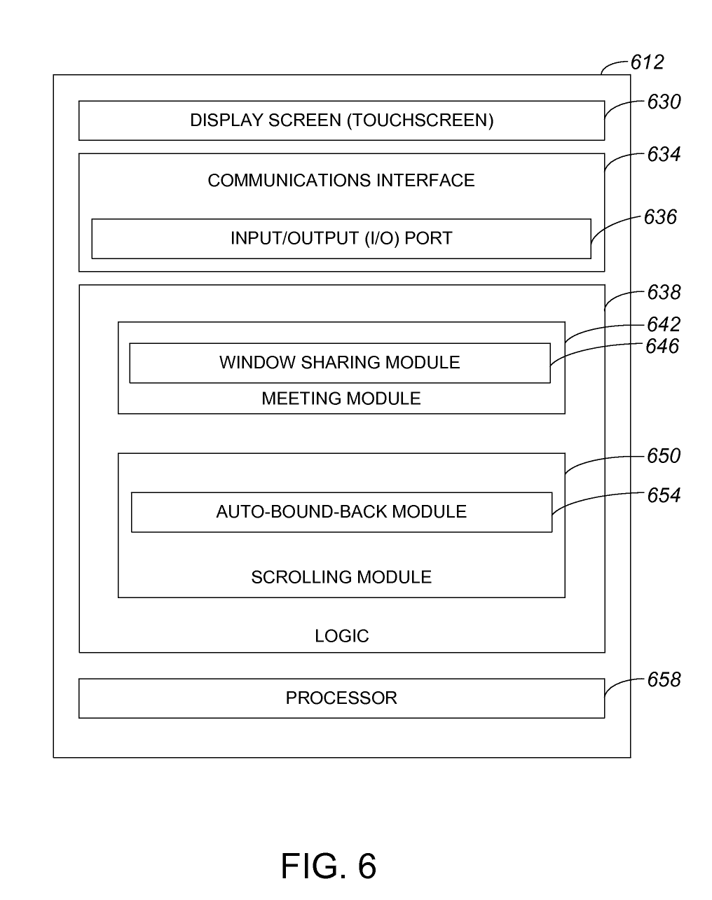

As mentioned above, auto-bound-back or the ability to substantially automatically bound back to a shared window when a remote attendee participating in a meeting scrolls past the borders of the shared window may be a mobile device such as a mobile or cellular phone. FIG. 6 is a diagrammatic representation of a mobile device in accordance with an embodiment. A mobile device 612 includes a display screen 630, a communications interface 634, logic 638, and a processor 658.

Display screen 630 may be any screen arranged to display at least a portion of a shared window of a display associated with a collaborative session or meeting, as well as scroll bars which may be used to scroll through the shared window. It should be appreciated that a size of display screen 630 may vary widely. In one embodiment, display screen 630 may be sized such that a display area of display screen 630 is smaller than a display area of a display used by a presenter during a collaborative session or meeting. Display screen 630 is generally a touchscreen that provides a user with an ability to use scroll bars.

Communications interface 634 is configured to allow mobile device 612 to communicate on a network. For example, communications interface 634 may be configured to receive and to send information on a wireless phone network or any other network configured to enable mobile device 612 to communicate with a meeting server. Communications interface 634 includes at least one input/output (I/O) port 636 which allows mobile device 612 to communicate with other components or elements on a network.

Logic 638 includes hardware and/or software logic configured to be executed by processor 658. Logic 638 includes a meeting module 642 and a scrolling module 650. Meeting module 642 is configured to enable device 612 to join and to participate in a meeting, e.g., a collaborative meeting in which visual content may be shared. A window sharing module 646 that is included in meeting module 642 allows mobile device 612 to engage in window sharing, e.g., sharing application windows, during the course of a meeting. That is, window sharing module 646 is arranged to allow mobile device 612 to share, e.g., to view, windows displayed on other devices during the course of a meeting. Scrolling module 650 is arranged to allow mobile device 612 to scroll with respect to a shared, active window of another device that is displayed on display screen 630. An auto-bound-back module 654 is included in scrolling module 650, and is configured to support auto-bound-back. Auto-bound-back module 654 is arranged to determine when a user of mobile device 612 has effectively scrolled past a border of a shared, active window displayed on display screen 630, and to determine whether to bound back to the shared, active window or to allow scrolling to continue. Upon determining that bound back is to occur, auto-bound-back module 654 may substantially automatically move display screen 630 relative to a shared, active window such that at least a portion of the shared, active window is displayed on display screen 630. In one embodiment, auto-bound-back module 654 may cause display screen 630 to substantially automatically bound back to a border of the shared, active window.

Although only a few embodiments have been described in this disclosure, it should be understood that the disclosure may be embodied in many other specific forms without departing from the spirit or the scope of the present disclosure. By way of example, an auto-bound-back process which allows a bound back or bounce back to substantially automatically occur is not limited to being implemented when it is detected that a mobile device has effectively scrolled past a border of a shared window. A bound back or bounce back may occur, for instance, when scrolling has been detected at a distance away from a border of a shared window. That is, an auto-bound-back process may be substantially triggered when scrolling is detected at a threshold distance from a border or an edge of a shared window, rather than when scrolling is detected as crossing the border.

Scrolling has generally been described as being accomplished by dragging a scroll bar or otherwise causing a scroll bar rendered on a screen to be moved along the screen. For instance, a user may place his or her finger, or a capacitive device such as a stylus, on a scroll bar and drag or move the scroll bar along the screen. It should be appreciated, however, that scrolling may be accomplished using any suitable method and is not limited to being accomplished by dragging or moving a scroll bar along a screen.

In lieu of determining coordinates of borders of a shared window associated with a collaborative session, other methods may be used to facilitate identifying when a mobile device participating in the collaborative session has effectively scrolled past the borders of the shared window. That is, any suitable method may be used to identify locations of borders or edges of a shared window. In one embodiment, a meeting application or client present on a computer of a current presenter may detect shared window coordinates and provide those coordinates to remote attendees or participants using mobile devices.

A device used by a remote attendee in a meeting, e.g., a mobile device in possession of the remote attendee, may be a mobile or cell phone, although it should be appreciated that a device used by a remote attendee is not limited to being a mobile or cell phone, The ability to initiate auto-bound-back may be implemented with respect to any device which includes a relatively small display screen, or a display screen that is smaller in size that a display screen used by a presenter during a meeting to share a window.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
identifying a shared window, the shared window being at least partially rendered on a screen of a device, the shared window having a first border, the first border defining an edge of the shared window;
determining if scrolling beyond the first border is detected;
if it is determined that scrolling beyond the first border is detected, determining whether bounding back to the shared window is indicated;
bounding back to the shared window if it is determined that bounding back to the shared window is indicated; and
allowing the scrolling beyond the first border to continue if it is determined that bounding back to the shared window is not indicated.

2. The method of claim 1 wherein a scroll bar is displayed on the screen, and wherein determining if scrolling beyond the first border is detected includes determining if scrolling has moved the scroll bar from scrolling over the shared window to scrolling beyond the first border.

3. The method of claim 2 wherein it is determined that scrolling beyond the first border is detected when the shared window is not rendered such that at least a partial rendering of the shared window fills the screen, and wherein bounding back to the shared window includes causing the scroll bar to move back to approximately the first border.

4. The method of claim 1 wherein determining whether bounding back to the shared window is indicated includes determining whether there is an intent to scroll beyond the first border.

5. The method of claim 1 wherein the shared window is associated with a collaborative meeting, the shared window being an active window associated with a current presenter in the collaborative meeting.

6. The method of claim 5 wherein allowing the scrolling beyond the first border to continue includes allowing the scrolling to continue to a first window associated with the collaborative meeting.

7. The method of claim 5 wherein the device is a mobile device, the mobile device being arranged to participate in the collaborative meeting.

8. The method of claim 1 wherein bounding back to the shared window includes bounding back to the first border.

9. A tangible, non-transitory computer-readable medium comprising computer program code, the computer program code, when executed, configured to:
identify a shared window, the shared window being at least partially rendered on a screen of a device, the shared window having a first border, the first border defining an edge of the shared window;
determine if scrolling beyond the first border is detected;
if it is determined that scrolling beyond the first border is detected, determine whether bounding back to the shared window is indicated;
bound back to the shared window if it is determined that bounding back to the shared window is indicated; and
allow the scrolling beyond the first border to continue if it is determined that bounding back to the shared window is not indicated.

10. The tangible, non-transitory computer-readable medium comprising computer program code of claim 9 wherein a scroll bar is displayed on the screen, and wherein the computer program code configured to determine if scrolling beyond the first border is detected is configured to determine if scrolling has moved the scroll bar from scrolling over the shared window to scrolling beyond the first border.

11. The tangible, non-transitory computer-readable medium comprising computer program code of claim 10 wherein it is determined that scrolling beyond the first border is detected when the shared window is not rendered such that at least a partial rendering of the shared window fills the screen, and wherein the computer program code configured to bound back to the shared window is configured to cause the scroll bar to move back to approximately the first border.

12. The tangible, non-transitory computer-readable medium comprising computer program code of claim 9 wherein the computer program code configured to determine whether bounding back to the shared window is indicated is configured to determine whether there is an intent to scroll beyond the first border.

13. The tangible, non-transitory computer-readable medium comprising computer program code of claim 9 wherein the shared window is associated with a collaborative meeting, the shared window being an active window associated with a current presenter in the collaborative meeting.

14. The tangible, non-transitory computer-readable medium comprising computer program code of claim 13 wherein the computer program code configured to allow the scrolling beyond the first border to continue is configured to allow the scrolling to continue to a first window associated with the collaborative meeting.

15. The tangible, non-transitory computer-readable medium comprising computer program code of claim 13 wherein the device is a mobile device, the mobile device being arranged to participate in the collaborative meeting.

16. The tangible, non-transitory computer-readable medium comprising computer program code of claim 9 wherein the computer code configured to bound back to the shared window is configured to bound back to the first border.

17. An apparatus comprising:
a processor;
a display screen; and
logic configured to be executed by the processor, the logic including a first module and a second module, the first module being arranged to allow the apparatus to join a collaborative session in which a window associated with the collaborative session is shared, the window having a border, the first module further being arranged to allow at least a portion of the window to be rendered on the display screen, the second module being arranged to allow scrolling to occur with respect to the display screen, the second module further being arranged to determine if scrolling past the border has occurred, wherein the second module is still further arranged to cause a bound back to the border if it is determined that scrolling past the border has occurred.

18. The apparatus of claim 17 wherein the second module is further arranged to identify an intent to scroll past the border, wherein the second module is arranged to cause the bound back to the border if the intent to scroll past the border is not identified and arranged to allow the scrolling to continue if it is determined that the intent to scroll past the border is identified.

19. The apparatus of claim 17 wherein the second module is arranged to cause the bound back to the border by causing at least the portion of the window to be rendered such that the display screen is filled.

20. The apparatus of claim 17 wherein the apparatus is a mobile device.
